(19) United States
(12) Patent Application Publication
(10) Pub. No.: US 2012/0223933 A1
(43) Pub. Date: Sep. 6, 2012

(54) ELECTROPHORETIC DISPLAY PANEL

(75) Inventors: Guofu ZHOU, Eindhoven (NL); Willibrordus Jurrianus DIJKMAN, Eindhoven (NL); Mark Thomas JOHNSON, Eindhoven (NL)

(73) Assignee: Adrea, LLC.

(21) Appl. No.: 13/411,952

(22) Filed: Mar. 5, 2012

Related U.S. Application Data
(63) Continuation of application No. 12/883,282, filed on Sep. 16, 2010, now Pat. No. 8,149,208.
Application No. 12/883,282 is a continuation of application No. 10/530,379, filed on Apr. 6, 2005, now Pat. No. 7,817,133.

(30) Foreign Application Priority Data
Oct. 10, 2002 (EP) 02079203.2

(51) Int. Cl. G09G 3/34; G06F 3/038

(52) U.S. Cl. 345/212; 345/107

(57) ABSTRACT

The electrophoretic display panel (1) for displaying a picture and a subsequent picture has drive means (100) which are able to control for each pixel (2) the potential difference to have a picture value to provide the pixels (2) with a respective picture appearance being either extreme or intermediate, subsequently to have an inter-picture value to provide the pixels (2) with a respective inter-picture appearance, and subsequently to have a subsequent picture value. For the display panel (1) to be able to provide the pixels (2) with the inter-picture appearances which are in general relatively little visible, the drive means (100) are able to control for each pixel (2) an estimate potential difference as the inter-picture value to provide the pixels (2) with a respective estimate picture appearance as the inter-picture appearance.

The invention relates to an electrophoretic display panel for displaying a picture and a subsequent picture.

An embodiment of the electrophoretic display panel of the type mentioned in the opening paragraph is described in the non-prepublished European Patent application 01200952.8 (PHNL 010161).

In the described electrophoretic display panel, the appearance of each pixel depends on the potential difference received by the electrodes of the respective pixel and on the history of the respective potential difference. As a consequence of the inter-picture value of the potential difference, the respective pixel has the inter-picture appearance, being substantially equal to one of the extreme appearances, which reduces the dependency on the history. As all pixels have substantially the same inter-picture value, the pixels have mutually substantially equal inter-picture appearances, before the subsequent picture is being displayed. Unfortunately, the pixels having the inter-picture appearances are well visible for an observer, if, as is generally the case, a substantial number of the pixels have intermediate appearances when one of the picture and the subsequent picture is being displayed. The pixels having the inter-picture appearances are less visible if the pixels have the inter-picture appearances during a reduced time interval. This can be realized by increasing the potential differences for providing the pixels with the inter-picture appearances. However, it is undesirable to increase the potential differences as the display panel is intended to operate at relatively low potential differences of for instance 15 Volts.

It is a drawback of the described display panel that the pixels having the inter-picture appearances are in general relatively much visible.

It is an object of the invention to provide a display panel of the kind mentioned in the opening paragraph which is able to have a reduced visibility of the inter-picture appearances of the pixels.

To achieve this object, the display panel in accordance with the invention is specified in claim 1.

The invention is based on the insight that, if the display panel is able to display an estimate of the subsequent picture, as a consequence of the pixels having the inter-picture appearances, the observer perceives a relatively smooth transition from the picture via the estimate of the subsequent picture to the subsequent picture. The display panel is able to display the estimate of the subsequent picture, because the drive means are able to control for each pixel an estimate potential difference as the inter-picture value to provide the pixels with a respective estimate picture appearance as the inter-picture appearance. As a result, the display panel is able to have a reduced visibility of the inter-picture appearances of the pixels.

In an embodiment the respective estimate picture appearance is substantially equal to one of the extreme appearances associated with the subsequent picture appearance. Then the dependency of the appearances of the pixels on the history of the potential differences is reduced.

In a variation of the embodiment the estimate picture appearance of each pixel is substantially equal
to the first extreme appearance if the respective subsequent picture appearance is optically closer to the first extreme appearance than to the second extreme appearance, and to the second extreme appearance otherwise.
   For instance, if the first and the second extreme appearance of each pixel are white and black, respectively, the pixels are provided with a respective inter-picture appearance substantially equal to white if the respective subsequent picture appearance is optically closer to white than to black, and substantially equal to black otherwise. As a result the estimate of the subsequent picture is being displayed by only substantially black and substantially white pixels, thereby being an estimate of the subsequent picture.

In another variation of the embodiment the drive means are further able to control for each pixel the potential difference for displaying the subsequent picture to have a sequence of preset values, the preset values in the sequence alternating in sign and having an absolute value in the order of the subsequent picture value, and to apply each preset value in the sequence for a duration being at least a factor of two smaller than a largest duration of the durations during which the subsequent picture values will be applied, before having the subsequent picture value. As an advantage, the sequence of preset values reduces the dependency of the appearances of the pixels on the history of the respective potential difference. Such sequences of preset values are described in the non-prepublished European Patent application 02077017.8 (PHNL020441). In a favorable variation of the embodiment the sequence of preset values has a last preset value with equal sign as the sign of the subsequent picture value. As an advantage the display panel has lower power consumption and a smaller duration of the subsequent picture value.

These and other aspects of the display panel of the invention will be further elucidated and described with reference to the drawings, in which:

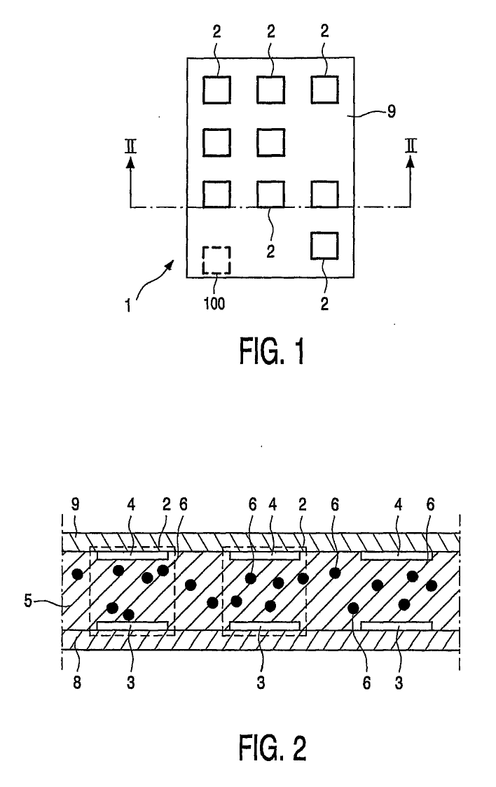

FIG. 1 shows diagrammatically a front view of an embodiment of the display panel;

FIG. 2 shows diagrammatically a cross-sectional view along II-II in FIG. 1;

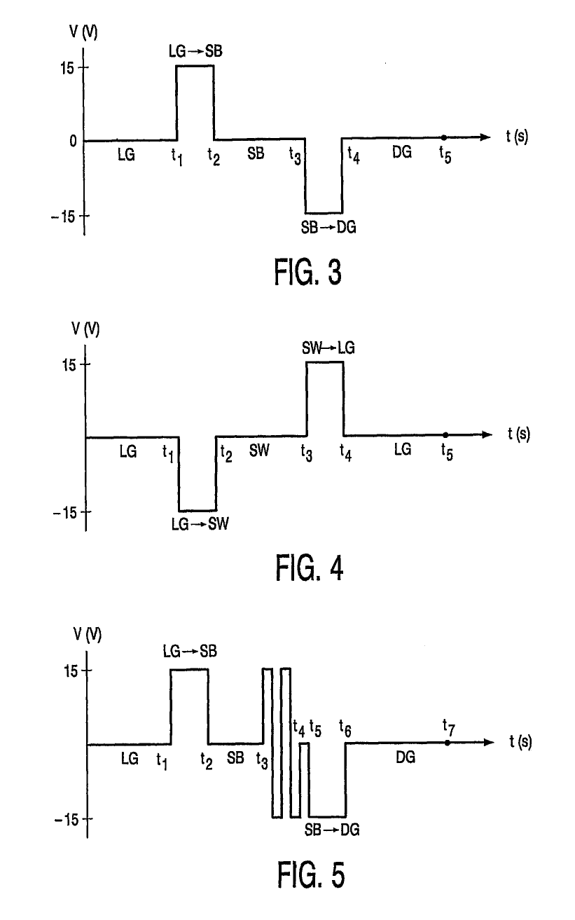

FIG. 3 shows diagrammatically the potential difference as a function of time for a pixel for a variation of the embodiment;

FIG. 4 shows diagrammatically the potential difference as a function of time for a pixel for the variation of the embodiment of FIG. 3; and

FIG. 5 shows diagrammatically the potential difference as a function of time for a pixel for a further variation of the embodiment.

In all the Figures corresponding parts are referenced to by the same reference numerals.

FIGS. 1 and 2 show the embodiment of the display panel 1 having a second substrate 9 and a plurality of pixels 2. The pixels 2 are arranged along substantially straight lines in a two-dimensional structure. Other arrangements of the pixels 2 are alternatively possible, e.g. a honeycomb arrangement. The display panel 1 has a first substrate 8 and a second opposed substrate 9. An electrophoretic medium 5 is present between the substrates 8,9. A first and a second electrode 3,4 are associated with each pixel 2. The electrodes 3,4 are able to receive a potential difference. In FIG. 2 the first substrate 8 has for each pixel 2 a first electrode 3, and the second substrate 9 has for each pixel 2 a second electrode 4. The electrophoretic medium 5 is able to provide each pixel 2 with an appearance, being one of a first and a second extreme appearance and intermediate appearances between the first and the second extreme appearance. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are positioned near the first electrode 3 due to a potential difference of 15 Volts, the pixel 2 has a first extreme appearance, i.e. white. When the charged particles 6 are positioned near the second electrode 4, due to a potential difference of opposite polarity, i.e. −15 Volts, the pixel 2 has a second extreme appearance, i.e. black. The intermediate appearances, e.g. light gray and dark gray, are gray levels between white and black. The drive means 100 are able to control for each pixel 2 the potential difference to have a picture value to provide the pixels 2 with a respective picture appearance, subsequently to have an inter-picture value to provide the pixels 2 with a respective inter-picture appearance, and subsequently to have a subsequent picture value to provide the pixels 2 with a respective subsequent picture appearance. Furthermore, the drive means 100 are able to control for each pixel 2 an estimate potential difference as the inter-picture value to provide the pixels 2 with a respective estimate picture appearance as the inter-picture appearance. Preferably, the respective estimate picture appearance is substantially equal to one of the extreme appearances associated with the subsequent picture appearance. The respective picture appearance is one of the appearances in dependence of the picture to be displayed and the respective subsequent picture appearance is one of the appearances in dependence of the subsequent picture to be displayed.

In a variation of the embodiment, the estimate picture appearance of each pixel 2 is substantially equal to the first extreme appearance if the respective subsequent picture appearance is optically closer to the first extreme appearance than to the second extreme appearance, and to the second extreme appearance otherwise. Optically closer may be related to e.g. luminance or brightness and may be defined on e.g. a linear scale or a scale including gamma-correction. Also the most significant bit of the subsequent picture information may be used to determine which extreme appearance is optically closer. As an example the picture appearance of a pixel 2 is light gray and the subsequent picture appearance of the pixel 2 is dark gray. For this example, the potential difference of the pixel 2 is shown as function of time in FIG. 3. For displaying the picture until time t1, the picture appearance of the pixel 2 is light gray, denoted as LG. As a result of the estimate potential difference of 15 Volts, between time t1 and time t2, representing e.g. 200 ms, the estimate picture appearance is substantially black, denoted as SB, because the subsequent picture appearance is dark gray, denoted as DG, which is optically closer to black than to white. The appearance remains substantially black between time t2 and time t3 due to the estimate potential difference of 0 Volts. The time interval between time t2 and t3 may also be absent. Between time t3 and time t4, representing e.g. 100 ms, the potential difference has the subsequent picture value of −15 Volts. As a result the appearance of the pixel 2 is dark gray. The appearance remains dark gray between time t4 and time t5, as then the subsequent picture value is 0 Volts. In another example both the picture appearance and the subsequent picture appearance of a pixel 2 are light gray. For this example, the potential difference of the pixel 2 is shown as function of time in FIG. 4. For displaying the picture until time t1, the picture appearance of the pixel 2 is light gray. As a result of the estimate potential difference of −15 Volts, between time t1 and time t2, the estimate picture appearance is substantially white, denoted as SW, because the subsequent picture appearance is light gray, which is optically closer to white than to black. The appearance remains substantially white between time t2 and time t3, due to the estimate potential difference of 0 Volts. Between time t3 and time t4 the potential difference has the subsequent picture value of 15 Volts. As a result the appearance of the pixel 2 is light gray. The appearance remains light gray between time t4 and time t5, as then the subsequent picture potential difference is 0 Volts.

In a variation of the embodiment the drive means 100 are further able to control for each pixel 2 the potential difference for displaying the subsequent picture to have a sequence of preset values, the preset values in the sequence alternating in sign and having an absolute value in the order of the subsequent picture value, and to apply each preset value in the sequence for a duration being at least a factor of two smaller than a largest duration of the durations during which the subsequent picture values will be applied, before having the subsequent picture value. As an example, the picture appearance of a pixel 2 is light gray and the subsequent picture appearance of the pixel 2 is dark gray. For this example, the potential difference of the pixel 2 is shown as function of time in FIG. 5. Until time t1 the picture appearance of the pixel 2 is light gray. As a result of the estimate potential difference of 15 Volts, between time t1 and time t2, the estimate picture appearance is substantially black and remains substantially black between time t2 and time t3 due to the estimate potential difference of 0 Volts. In the example, the potential difference for displaying the subsequent picture has a sequence of 4 preset values, subsequently 15 Volts, −15 Volts, 15 Volts and −15 Volts, applied between time t3 and t4. Each preset value is applied for e.g. 20 ms. The time interval between t4 and t5 is negligibly small. Subsequently, between time t5 and time t6, representing e.g. 80 ms, the subsequent picture value of the potential difference is −15 Volts. As a result the appearance of the pixel 2 is dark gray. Favorably, as shown in FIG. 5, the last preset value and the subsequent picture value have equal sign. The appearance remains dark gray between time t6 and time t7, due to the subsequent picture potential difference of 0 Volts.

It will be apparent that within the scope of the invention many variations, e.g. display panels having colored pixels, are possible for a person skilled in the art.

1.-5. (canceled)

6. An electrophoretic display device comprising:
first and second pixels comprising electrodes and particles interposed between the electrodes; and
a driving circuit configured to calculate and supply first and second driving voltages to the first and second pixels, respectively, so as to give the first and second pixels inter-picture appearances between picture appearances,
the first driving voltage causing the first pixel to display a first extreme appearance, and
the second driving voltage causing the second pixel to display a second extreme appearance opposite to the first extreme appearance.

7. The electrophoretic display device according to claim 6, wherein the driving circuit calculates and supplies the first driving voltage to the first pixel when a picture appearance immediately following the first extreme appearance is optically closer to the first extreme appearance than to the second extreme appearance.

8. The electrophoretic display device according to claim 6, wherein the driving circuit calculates and supplies the second driving voltage to the second pixel when a picture appearance immediately following the second extreme appearance is optically closer to the second extreme appearance than to the first extreme appearance.

9. The electrophoretic display device according to claim 6, wherein the driving circuit is configured to:
supply a sequence of preset voltages interposed between the first voltage and a picture voltage causing the first pixel to display one of the picture appearances, the preset values in the sequence alternating in sign and having an absolute value in the order of the picture voltage; and
apply each of the preset values for a duration being at least a factor of two smaller than a duration of the picture voltage.

10. The electrophoretic display device according to claim 6, wherein the last preset value in the sequence has a sign equal to the sign of the picture voltage.

11. An electrophoretic display device comprising:
a pixel comprising electrodes and particles interposed between the electrodes; and
a driving circuit configured to calculate and supply the pixel with a driving voltage so as to give the pixel an inter-picture appearance between picture appearances, the driving circuit calculating the driving voltage dependent on a picture appearance following the inter-picture appearance so that the inter-picture appearance being one of a first extreme appearance or a second extreme appearance opposite to the first extreme appearance.

12. The electrophoretic display device according to claim 11, wherein the inter-picture appearance is the first extreme appearance when the picture appearance is optically closer to the first extreme appearance than to the second extreme appearance.

13. The electrophoretic display device according to claim 11, wherein the inter-picture appearance is the second extreme appearance when the picture appearance is optically closer to the second extreme appearance than to the first extreme appearance.

14. The electrophoretic display device according to claim 11, wherein the driving circuit is configured to:
supply a sequence of preset voltages interposed between the driving voltage and a picture voltage causing the pixel to display the picture appearance, the preset values in the sequence alternating in sign and having an absolute value in the order of the picture voltage; and
apply each of the preset values for a duration being at least a factor of two smaller than a duration of the picture voltage.

15. The electrophoretic display device according to claim 14, wherein the last preset value in the sequence has a sign equal to the sign of the picture voltage.
